(19) United States
(12) Patent Application Publication
(10) Pub. No.: US 2025/0388432 A1
(43) Pub. Date: Dec. 25, 2025

(54) Compensating Helically Grooved Drum Sheaves

(71) Applicant: Thomas Patrick Moyer, Lagrangeville, NY (US)

(72) Inventor: Thomas Patrick Moyer, Lagrangeville, NY (US)

(21) Appl. No.: 18/748,203

(22) Filed: Jun. 20, 2024

(51) Int. Cl. B65H 75/26

(52) U.S. Cl. CPC B65H 75/265

(57) ABSTRACT

Single layer wrapped helically grooved drum sheaves with non-invariant groove helical angle are disclosed which have zero fleet angle over their entire extent, calculable for any application. These drums can be paired with pulleys rotating parallel to the drum axis, to give complete drum and pulley systems having zero fleet angle over their full range of motion. These drums can alternately be paired with non-rotating cable terminating attachments, to give complete drum and attachment systems having zero fleet angle over their full range of motion. For single layer wrapped drum and pulley cable systems as well as for single layer wrapped drum and attachment cable systems; the present invention enables complete elimination of the service lifespan reduction arising from non-zero fleet angles. Another implementation benefit is reduction in elevator mechanical compartment size using the zero fleet angle tradeoff between drum length and drum to pulley separation.

### REFERENCE TO RELATED PATENTS

U.S. Pat. No. 3,078,060 Le Bus Sr September 1960
U.S. Pat. No. 3,083,932 Crowley April 1963
U.S. Pat. No. 3,122,341 Le Bus Sr February 1964
U.S. Pat. No. 3,182,961 Le Bus Sr May 1965
U.S. Pat. No. 3,206,139 Smith September 1965
U.S. Pat. No. 3,379,393 Pilcher April 1968
U.S. Pat. No. 3,652,029 Stewart March 1972
U.S. Pat. No. 3,690,409 Brauss September 1972
U.S. Pat. No. 4,002,321 Shaw January 1977
U.S. Pat. No. 4,015,798 Benya April 1977
U.S. Pat. No. 4,235,394 Fry November 1980
U.S. Pat. No. 4,778,121 Minnee October 1988
20110193037A1 Smith August 2011
20170088388A1 Lillich March 2017
20180229983A1 Isherwood August 2018
20180251352A1 Ijadi-Maghsoodi September 2018
20190135595A1 Lindberg May 2019
20200156907A1 Boroy May 2020
20220112055A1 Vaughn April 2022

### BACKGROUND OF THE INVENTION

A longstanding need has existed for minimizing fleet angle in cable reeving. Fleet angle is defined for the grooved single layer drum sheaves of the present invention, as the angle of misalignment between a groove entrained cable and the entraining groove at the location of cable departure from the drum. Non-zero fleet angles cause axial twisting of the cable, or frictional cable wear, or both. These detrimental effects occur as the cable is spooled onto the drum, and as the cable is released (unspooled) from the drum. In spooling, a non-zero fleet angles causes that portion of the cable which is just coming into contact with the drum to have that contact occur some portion of the way up the side of the groove. As the drum rotates further, the cable rolls and/or slides toward the groove bottom. In unspooling, the cable transitions from the groove bottom to a position higher up the side of the groove, while being pressed against the side of groove with the transit again being cable sliding, cable rolling, or some combination of the two. The sliding is an abrasive action and reduces the service lifespan of both the cable and the drum. The rolling is a twisting of the cable along the cable longitudinal axis and results in sometimes undesired load rotational moments. Higher magnitudes of fleet angle induced twisting can result in cables kinking upon unloading. If a kinked cable is subsequently reloaded the cable might fail catastrophically.

Prior art grooved drum sheaves have grooves with an invariant helical angle, which causes the fleet angle to vary as rotation of the drum migrates the cable-to-drum departure location along the axis of the drum as the cable to payed out or in. Reeving guidelines have addressed this by extending the distance between the drum and the next proximal cable redirecting element, often a pulley. By increasing this distance, the fleet angle can be kept below an industry suggested maximum, often 1.5 degrees. This required minimum drum to pulley distance has come into conflict with the desire to have ever more compact mechanical reeving compartments.

### SUMMARY OF THE INVENTION

The present invention changes the groove helical angle of single layer wrap drum sheaves to achieve alignment of the cable departure angle to the groove helical angle at all locations along the drum. This disclosure allows zero fleet angle to be achieved over the full range of drum cable pay-in and pay-out.

Zero fleet angle pulley orientations are presented for drum proximal cable redirection pulley elements. Zero fleet angle attachment orientations are presented for appropriately curved drum proximal cable attachment elements. The combination of a drum with the herein disclosed compensating groove, with either of these proximal cable entities enables reeving with zero fleet angle on both the drum and proximal cable entity over the full range of cable entrainment on the drum and cable distention from the drum.

A numerical calculation method is disclosed which enables calculation of a compensating groove for any pairing of a single layer wrapped drum sheave and a proximal cable interaction element. The calculations are analogous to the classic mathematical series of moving half the distance to a desired location, then repeatedly moving half the remaining distance. The fleet angle reduction instance of this tactic is to choose a convenient initial circumferential angle and re-align the helical angle at successive increments of this angle. The circumferential angle incrementing is complete when the application required length of extendable cable has been matched to the periodically helical angle modified groove length. Completion of this iterative process is defined as completing an initial angle sequence. The drum axial length at which the initial angle sequence completes, is recorded. Successive initial angle sequences choose relationally smaller, typically ½ the prior iteration, initial angle choices. The axial length at which the desired groove length occurs converges on a limiting value. The sequencing from successively smaller initial angles can be halted when the difference between sequences result in axial length differences less than some specified distance. The smallest real world specifiable axial groove position machinable tolerance is a workable, reasoned limit to the iteration of sequences, and is the most preferred implementation of the current invention.

Compensated helically grooved drum sheaves can be used with current generation, inexpensive motion control hardware. Time dependent numerical positional control inputs are typically translated into, and implemented as, end effector movements by a data processing pipeline. Drum sheaves with the prior art invariant helical angle grooves have a linear relation between drum rotation extent and amount of cable pay-in or pay-out. Compensatingly grooved drums are slightly non-linear in this relation and this non-linearity must be addressed to give desired end effector motion.

The standard pipeline is to first convert a design into a numerical control descriptor, with this descriptor often being implemented as G-Code. An interface program then conveys a modified and/or enhanced and/or compressed version of the descriptor to an electronic microcontroller. A microcontroller is necessary as the single program executing therein is not interrupted by time slice allocations for other processes and threads. Such interruptions would disrupt the time critical outputs necessary for motion control. The microcontroller implements the final portion of the data pipeline by translating the concepts expressed in the descriptor into formatted electrical signals which operationally interact with motion implementation electronics, causing one or more motors to impart force to end effector mechanically connected components. The most preferred location for re-linerialization of the data pipeline is within the microcontroller code.

An exemplary implementation is provided for in the grbIHAL code package which runs on several inexpensive microcontrollers. Within the grbIHAL code is a selector location wherein the alternatives to the default linear relation between input co-ordinates and motor translation can be selected. The currently implemented alternatives are the CoreXY, and the wall plotter, the most widely implemented CNC application thereof being the first generation Maslow CNC.

### BRIEF DESCRIPTION OF DRAWINGS

FIG. 1A: Perspective illustration of a compensated drum, pulley pair.

FIG. 1B: Orthographic front view of the FIG. 1A pair.

FIG. 2A: Orthographic top view of a prior art, non-compensated drum, pulley pair.

FIG. 2B: The pair of FIG. 2A, with the drum compensated at 1 wrap.

FIG. 2C: The pair of FIG. 2A, with the drum compensated at 1 and 2 wraps.

FIG. 2D: The pair of FIG. 2A, with the drum compensated at 1 and 2 and 3 wraps.

FIG. 3: Table of compensation periodicity convergence for the pair of FIG. 4.

FIG. 4: A drum, pulley pair with drum compensated every 1/256 degree.

FIG. 5: Preferred orientation of a drum, pulley pair.

FIG. 6: Cable positions at integer drum rotations for pair of FIG. 4.

FIG. 7: Cable positions at integer drum rotations for pair of FIG. 5.

FIG. 8: Table relating elevator height to required compensating drum length.

FIG. 9A: Compensating drum for 6 meter elevator.

FIG. 9B: Portion of FIG. 9A drum highlighting transition from dead wraps to live wraps.

FIG. 10: Compensating drum for 12 meter elevator.

FIG. 11: Compensating drum for 18 meter elevator.

FIG. 12: Closed form solutions to lines from outside point, tangent to circle.

FIG. 13: NURB helix control points.

FIG. 14: Perspective view of compliant cable attachment with strain relief.

FIG. 15: Orthographic view of FIG. 14 attachment and compensated drum pair.

### DETAILED DESCRIPTION OF THE INVENTION

The following paragraphs are descriptions of exemplary terms and embodiments of the disclosed invention. Except where noted otherwise, variants of all terms, including singular forms, plural forms, and other affixed forms, fall within each exemplary term meaning. Except where noted otherwise, capitalized and non-capitalized forms of all terms fall within each meaning. Similarly the present invention is not limited to the particular embodiments depicted, but rather applies to any helically grooved single wrap depth drum sheave having one or more locations at which the helical groove angle is modified to reduce the fleet angle at that location.

Closed form mathematical solutions to some or all orientations of paired compensating helically grooved single layer wrapped drum sheave and proximal cable interaction elements may be possible. The present inventor was, however, unable to discern any of these. Numerical methods are disclosed which converge on a limiting value for the groove location at all positions along the groove which differ from this limiting value by less than machinable tolerances. These numerical calculation methods have been implemented and have proven workable on a non-parallelized, commodity 64 bit desktop general purpose computing resource using standard java libraries including those related to trigonometric functions. Calculation times, using disclosed numerical calculation tactics, have been less than an hour for any given set of the important geometric inputs: drum radius, cable radius, pulley or attachment curvature, and drum to cable separation.

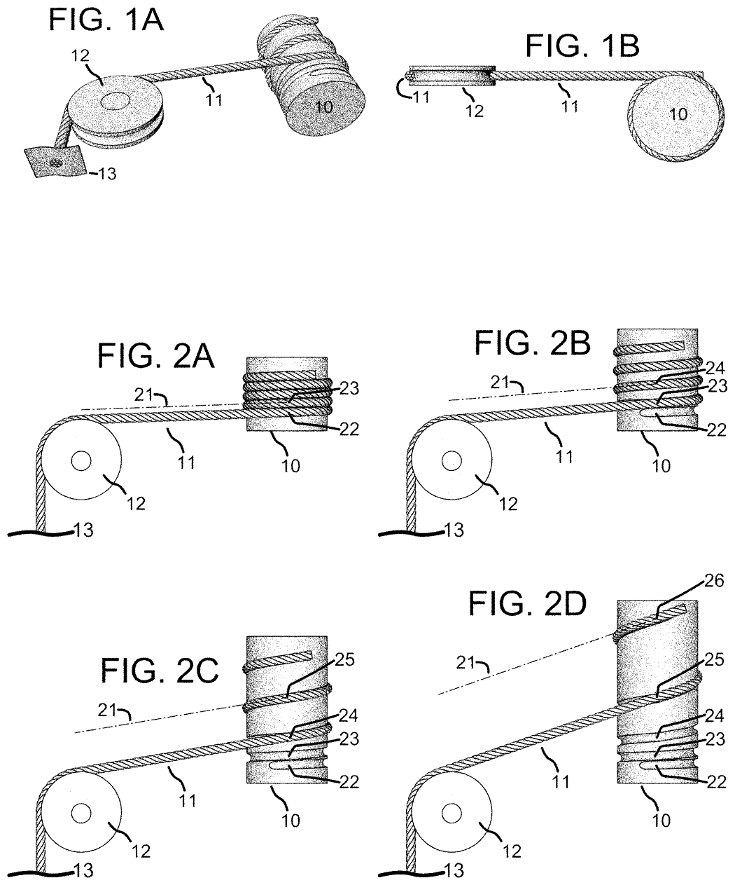

FIG. 1A has helically grooved single wrap depth drum 10 with cable 11 extending over pulley 12. Display cutoff indicator 13 separates that portion of cable 11 included in the figure from the portion of cable 11 which extends beyond the figure depiction bounds.

FIG. 1B, an orthogonal view of the components in FIG. 1A, highlights the orientation of the pulley for a zero fleet angle drum, pulley pair. The pulley is oriented such that the pulley defined plane within which the cable bends, is tangent to the drum at the radius of the cable drum wraps. This further implies that the axis around which the pulley rotates is perpendicular to the drum rotation axis.

FIGS. 2A, 2B, 2C, and 2D are orthographic views depicting sequential application of compensating helical groove angle modifications to a drum, pulley pair. FIG. 2A is a baseline prior art drum 10 grooved with an invariant helical angle having 5 wraps of cable 11 around drum 10. In each of FIGS. 2A, 2B, 2C, and 2D, projection indicator 21 starts from a point along the cable 11, said point being one complete drum wrap along the drum 10 groove whence cable 11 contacts drum 10. The indicator 21 projects out as far as the distance spanned by cable 11 extending between drum 10 and pulley 12. The pulley 12 proximal end of indicator 21 is removed from pulley 12 by some distance. In FIG. 2A cable 11 contacts drum 10 at location 22, with indicator 21 contacting the drum at location 23. Rotation of groove helical angle indicator 21 about location 23, said rotation occurring within the plane of the paper, by an amount which reestablishes contact of the cable 11 to pulley 12 is the optimal groove angle compensation to be applied location 23. Numerical calculation of this compensation angle is straightforward as the formula for the “tangents to a circle from an outside point” is available as a closed form solution published by several sources, and is easily obtained with an internet search.

FIG. 2B shows the effect of the initial groove compensation at location 23. The first groove rotation around the drum 10, from location 22 to location 23, is unchanged, but the groove rotations corresponding to further paying out of the cable 11 are at the new, compensated location 23 helical angle. FIG. 2C shows the effect of groove compensation at location 24. The second groove rotation around the drum 10, from location 23 to location 24, is unchanged, but the groove rotations corresponding to further paying out of the cable 11 are at the new, compensated location 24 helical angle. FIG. 2D shows the effect of groove compensation at location 25. The third groove rotation around the drum 10, from location 24 to location 25, is unchanged, but the groove rotations corresponding to further paying out of the cable 11 are at the new, compensated location 25 helical angle.

The sequence of groove angle compensations occurred at a large drum circumferential angle of one complete rotation, also known as 360 degrees. This periodicity aided illustration as the pulley proximal ends of indicator 21 were substantial distances from the pulley, indicating substantial changes in helical angle being required. The large amount of cable, full wraps, between these infrequent adjustment locations experience substantial fleet angles.

A number of variables significantly affect the geometry of a compensated helically grooved drum sheave. The distance between the drum 10 and the proximal cable 11 redirection element, often a pulley 12, is of primal importance. Further apart is better in that it results in a smaller drum 10 length for any application dictated cable 11 pay-out length requirement. The cable 11 diameter effects the drum 10 diameter as many applications have regulations specifying the minimum ratio of drum 10 diameter vs cable 11 diameter. The larger this ratio is, the less the cable 11 will be bent as it is wrapped/unwrapped from the drum 10. Less bending is beneficial as it is associated with longer cable 11 service lifespan. Cable and drum sheave manufactures often have design guidelines suggesting drum 10 to cable 11 diameter ratios larger than the regulated minimums. Cable diameter minimum is often a result of application requirements for cable 11 service use load maximums. Service use load maximum has two components: manufacturers minimum specified breaking strength for a given cable diameter, material, and strand configuration, and the application jurisdiction specific required derating factor. Regulations often require designs to use cable 11 loads at no greater than ¼ or ⅕ of their published cable 11 breaking strength. Drum diameter affects the force available from any given motor+transmission system, with larger diameters linearly decreasing the force delivered from the motor+transmission torque. Larger drum 10 diameters entrain more cable 11 per rotation. The designer of a drum 10, cable 11, pulley 12 system must make tradeoffs among force available, drum 10 diameter, cable 11 diameter, motor maximum torque, and motor transmission speed-reduction/torque-increase factor.

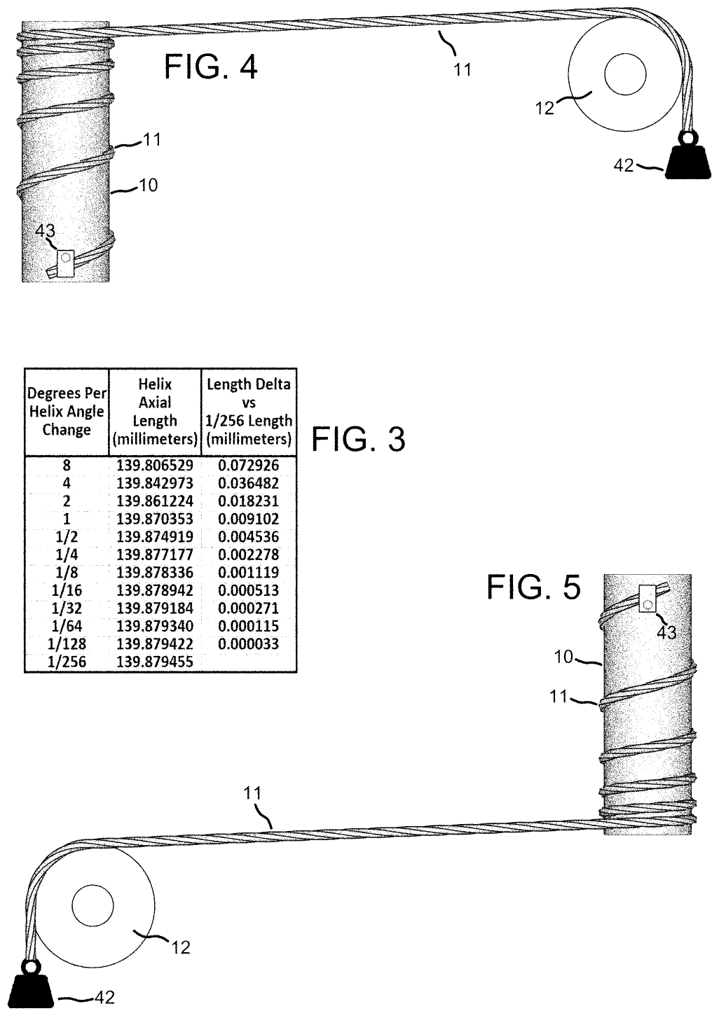

The substantial fleet angle corrections needed after each of the complete 360 degree drum 10 rotations shown in FIG. 2 are primarily due to the small distance between drum 10 and pulley 12 chosen for this figure. For every application, every groove angle correction causes an increase in the drum 10 axial length at which a given cable 11 length is groove entrained. This in turn causes calculation sequences with smaller separation between groove angle corrections to grow longer. FIG. 3 reflects this trend for an exemplary drum 10 and pulley 12 configuration. The leftmost column enumerates the drum rotation angle periodicity at which the groove angle compensations occur. The top row thus reflects drum circumferential groove angle compensations every 8 degrees of drum 10 rotation, until a given length of cable 11 is groove entrained. The middle column is the location of the groove, measured along the drum 10 axis, at which this given cable 11 groove entrainment occurs. Each row below the highest has the drum rotation periodicity as ½ the periodicity of the row above. Those as are skilled in the art of mathematical series analysis will find two aspects of this numerically calculated sequence satisfying. The sequence converges rapidly and in good order toward a limiting value. The difference between the length calculated using drum 10 angular rotations of every 1/128 of a degree differs from the length calculated using drum 10 angular rotations of every 1/256 of a degree by only 33 nanometers. That the sequence converges with well proportioned differences, each incrementally smaller, indicates that the 64 bit java standard library processing of trigonometric functions does not have systematic skew or other accumulating round-off errors.

FIG. 4 and FIG. 5 introduce two geometric orientations for drum 10 and pulley 12 pairs. Both have weight 42 suspended from cable 11 which spans the distance between pulley 12 and drum 10, with cable clamp 43 fixing an end of the cable 11 to drum 10. In FIG. 4, the weight distal cable 11 contact departure from pulley 12 migrates closer to drum 10 as cable is payed out. This is defined as a pay-out-closer arrangement. In FIG. 5, the weight distal cable 11 contact departure from pulley 12 migrates further from drum 10 as cable is payed out. This is defined as a pay-out-further arrangement.

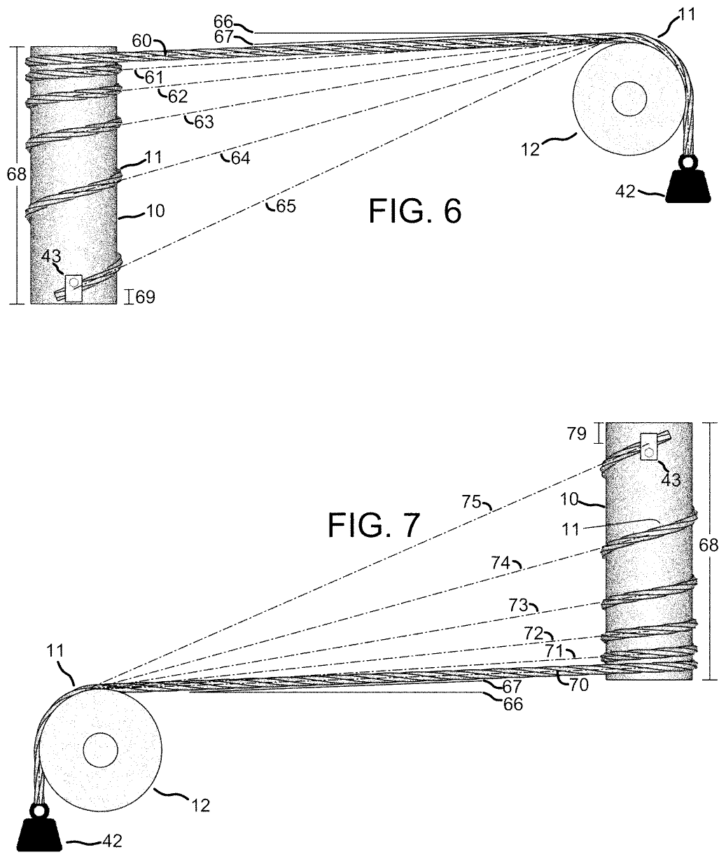

FIG. 6 is the pay-out-closer arrangement of FIG. 4 with additional optical guides to help clarify the pay-out-closer nature of this arrangement. Drum axis orthogonal line 66 is shown here as horizontal relative to a vertical drum 10 axis. Initial angle indicator line 67 indicates the initial helical groove angle at the FIG. 4 cable groove departure location distal to the cable clamp 43. Cable 11 centerline Indicator 60 is overlaid on the cable 11 position relating to weight 42 being in the as-drawn location.

Cable 11 centerline indicator 61 would be overlaid on the cable 11 position relating to weight 42 being payed out by one complete rotation of drum 10 beyond the position depicted. That payout and the payouts associated with the centerline indicators 62 through 65 are associated with clockwise rotation of drum 10 as viewed from the drum 10 clamp 43 end. Each of the sequential centerline indicators 62 through 65 is associated with an additional full drum 10 rotation of 360 degrees. The progression of centerline indicator lines near the pulley 12 is intended to allow visualization of the progression of the cable 11 to pulley 12 contact location as the cable 11 is payed out. Length 68 is the full length of drum 10 with length 69 indicating the distance between the length of drum 10 and the location at which the drum 10 helical groove completes it's fifth rotation.

FIG. 7 is the pay-out-further arrangement of FIG. 5 with additional optical guides to help clarify the pay-out-further nature of this arrangement. Cable 11 centerline Indicator 70 is overlaid on the cable 11 position relating to weight 42 being in the as-drawn location.

Cable 11 centerline indicator 71 would be overlaid on the cable 11 position relating to weight 42 being payed out by one complete rotation of drum 10 beyond the position depicted. That payout and the payouts associated with the centerline indicators 72 through 75 are associated with clockwise rotation of drum 10 as viewed from the drum 10 clamp 43 end. Each of the sequential centerline indicators 72 through 75 is associated with an additional rotation of drum 10. The progression of centerline indicator lines near the pulley 12 is intended to allow visualization of the progression of the cable 11 to pulley 12 contact location as the cable 11 is payed out. Length 68 is the full length of drum 10 and is the same length as the FIG. 6 drum 10 length. Length 79 indicates the distance between the length of drum 10 and the location at which the pay-out-further FIG. 7 drum 10 helical groove completes it's fifth rotation. Length 79 is longer than length 69. This relates to a shorter axial length of the pay-out-further arrangement. The shorter axial length of the pay-out-further arrangement causes it to be the preferred arrangement.

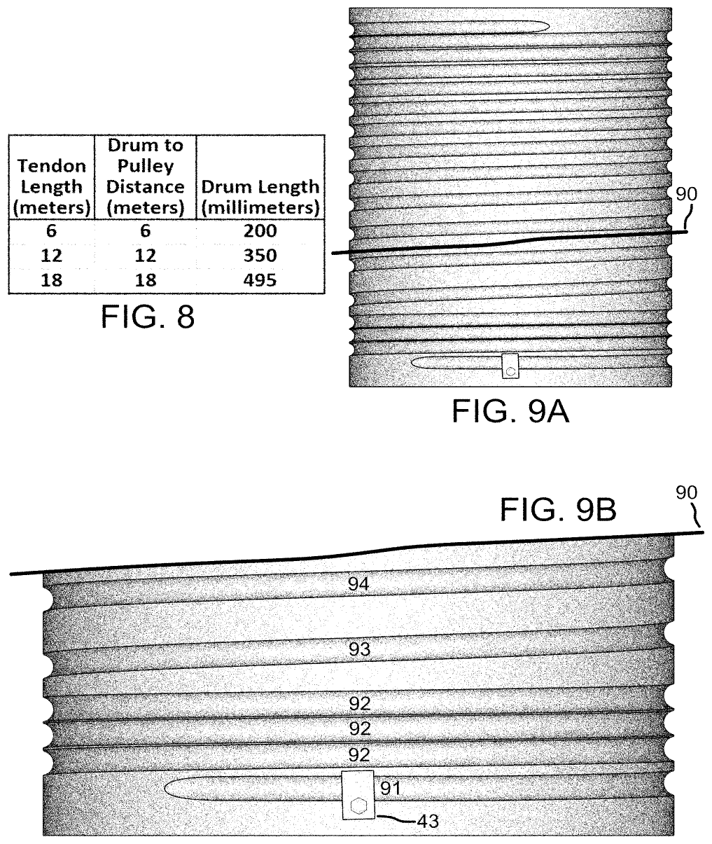

The exemplary drum 10 and pulley 12 arrangements in the first 7 figures had drum to pulley separation distances which were useful for illustration, but would likely not be appropriate for any real application. The small separations cause excessive angular compensations and result in unworkable long lengths for drum 10. FIG. 8 shows the drum 10 length for cable tensile truss elevators having a the drum 10 at the bottom of the shaft, with a pulley at the shaft top from which the cable 11 then descends to the elevator cab. Shaft lengths of 6, 12, 18 meters were used as these were seen as adequate for elevators for 2, 3 and 4 story buildings covering single family homes and many hotels. The other parameters used are ¼ inch diameter cable 11 with 160 mm diameter drum 10.

FIG. 9A is the full drum 10 for a 6 meter separation between drum 10 and pulley 12, said drum entraining 6 meters of extendable cable 11. Image cut line 90 indicates the section below which is shown as FIG. 9B. FIG. 9B is a larger scale view of the cable clamp 43 end of the drum of FIG. 9A. Groove 91 in this drum 10 design is perpendicular to the drum 10 axis at cable clamp 43. The first wrap of the helical groove transitions to the prior art, slightly spaced wrap to wrap spacing for three dead wraps 92. The description of the FIGS. 9A and 9B drum 10 as having a number of meters of extendable cable excludes these dead wraps as well as the transition wrap 93 from the extendable length of entrained cable 11. Groove wrap 94 is the cable clamp proximal compensated groove.

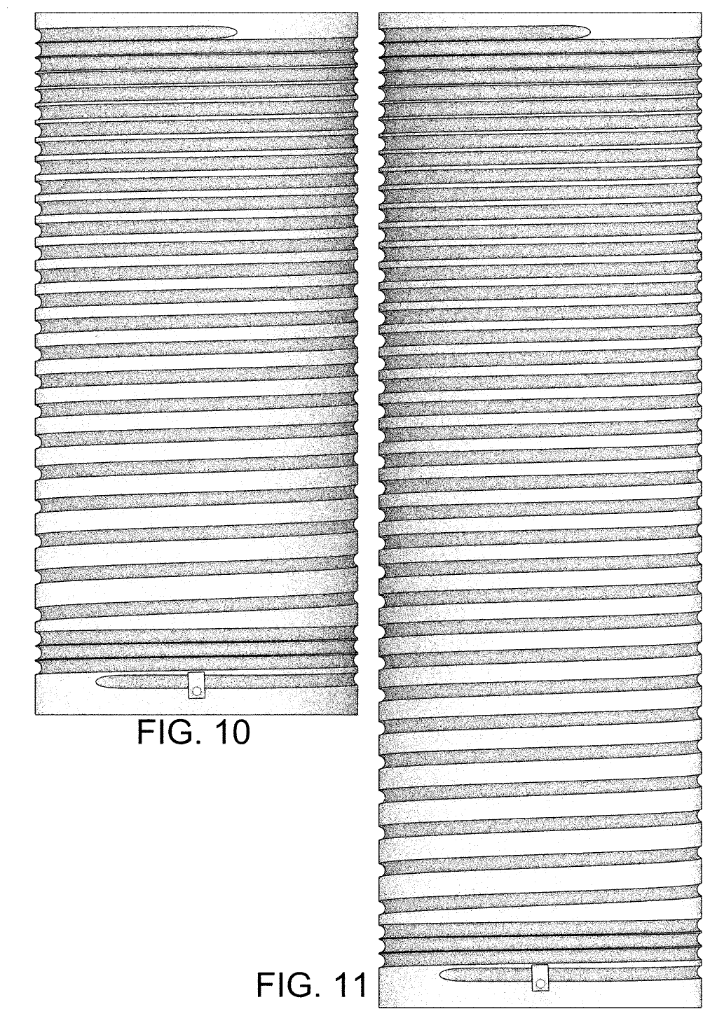

FIG. 10 is the drum 11 which incorporates 3 full dead wraps, a transition wrap, and compensated groove wraps which entrain 12 meters of extendable cable 11.

FIG. 11 is the drum 11 which incorporates 3 full dead wraps, a transition wrap, and compensated groove wraps which entrain 18 meters of extendable cable 11.

Programming the present invention without recourse to 3D graphical feedback may be possible, but those skilled in the art will recognize the utility of visualizing geometric component setups and solutions. Graphical feedback using commercial 3D CAD packages allows quick debugging of enabling code, and suggests the mathematical formulations which have been found by others to be optimal in a number of aspects.

FIG. 12 is an example of this geometric visualization graphical feedback utility. The solution for lines tangent to a circle, here the pulley 12, from an exterior point 120, always has two solutions. Line segments from 120 to 121 and from 120 to 122 are both tangent to pulley 12. In the closed form solution, these two lines conform to a “plus” or “minus” at a single location within the formula. This is similar to the “plus” or “minus” in the perhaps more familiar quadratic equation. For the programming implementer, selecting from among these two solutions, i.e. retaining and propagating the helix with one and not the other of these two solutions need be made only once, but it is imperative that the selection be done correctly. With aid of a visualization analogous to FIG. 12, the solution selection corresponding to the segment from 120 to 121 is easily seen as the correct choice.

The NURBS representation of helices, as is used by the Rhino CAD program, is the most preferred numeric representation of the disclosed compensated helical grooves. NURBS represent smoothly varying curves to great precision, are well documented, and are quite compact. The translation of the compensation locations into NURBS representation is trivial: use the compensation 3D locations as the NURBS control points, and space the NURBS knots proportional to the drum circumferential angle spacing. The compact nature of NURBS has an especially desirable application to the exemplary calculation technique presented for compensating the helical angle at a finely spaced periodicity of drum rotational angles. One can select a regular subset of these compensation locations as the NURBS control points and have a compact NURB which very precisely approximates the NURB using the full complement of compensation locations. A NURB helical curve with control points only every 8 degrees circumferentially perpendicular to the helix axis will often differ from the NURB with control points every 1/256 of a degree by less than achievable machinable tolerances.

The most preferred interaction between developer code and the commercial CAD systems is to select one of the input/output formats from the CAD system, and to develop code to express the disclosed helices in that format. The preferred file format for this code to CAD exchange is the Wavefront.obj format. This well documented, ascii format represents NURBS, without excessive overhead file headers or footers, with the expression easily understood by those skilled in the art.

A further advantage of exporting the present invention compensated helical grooves into a CAD system, is that embodiments of the mathematical constructs can be pipelined into existing CAD/CAM operations. An example of one such sequence would be to first calculate and output a compensated helix in a selected data interchange format. Input the helix line curve into a cad system and use the cad system to “pipe” the curve to become a tube. Position an appropriately sized cylinder coaxial with the piped helix tube, and use the CAD system boolean difference function to create the relatively complex surface of a grooved drum sheave. 3D printing is then enabled by exporting the grooved drum shape in a 3D printing format standard on most CAD systems.

FIG. 13 shows the default solution control points chosen for a four wrap helix made by the Rhino CAD system. End points 120 and 130 are vertically above the drum 10 rotary axis. End control point 120 nearest neighbor control point 131 is three degrees clockwise along the groove as viewed from the drum 10 end closer to control point 120. End control point 130 nearest neighbor control point 132 is three degrees circumferentially counterclockwise along the groove as viewed from the same direction. The circumferential separation along the groove between 120 and 133, and between 130 and 134 and between 134 and 135 and between each of the unnumbered control points between 133 and 135 is a uniform 10 degrees.

Two calculation tactics will be appreciated by those skilled in the programming arts. Of lesser import is the tactic of making the calculations based on compensation locations spaced initially at eight degrees circumferentially perpendicular to the helix axis and bifurcating the location spacing with each successive calculation pass. The increase from 36 to 45 locations per wrap rotation is modest and allows the sequential passes to be the easily expressible 8, 4, 2, 1, ½, ¼, . . . sequence. Of greater import, is that in calculating control points in the compensation calculations, retention of the end control point neighbor as being closer than the bulk uniform circumferential control point separation inflicts substantial and needless pain on the calculation program embodiment. The advantage of having the end control point neighbor nearer to the end control point is that the NURB has better conformance of the tangent (first derivative) to a mathematical helix described by the NURB at that end point. This advantage can be easily obtained as a corollary of having noted that selecting a regular moderately spaced, such as every 8 degrees, subset from a fully regular, finely separated control point list gives an excellent approximation of the NURB described by the finer list. After selecting a moderately spaced subset of the compensation locations i.e. NURB control points, pick an additional pair of compensation locations near to the two end points from among the finely separated control point list and insert them between the moderately spaced list end points and their nearest neighbors.

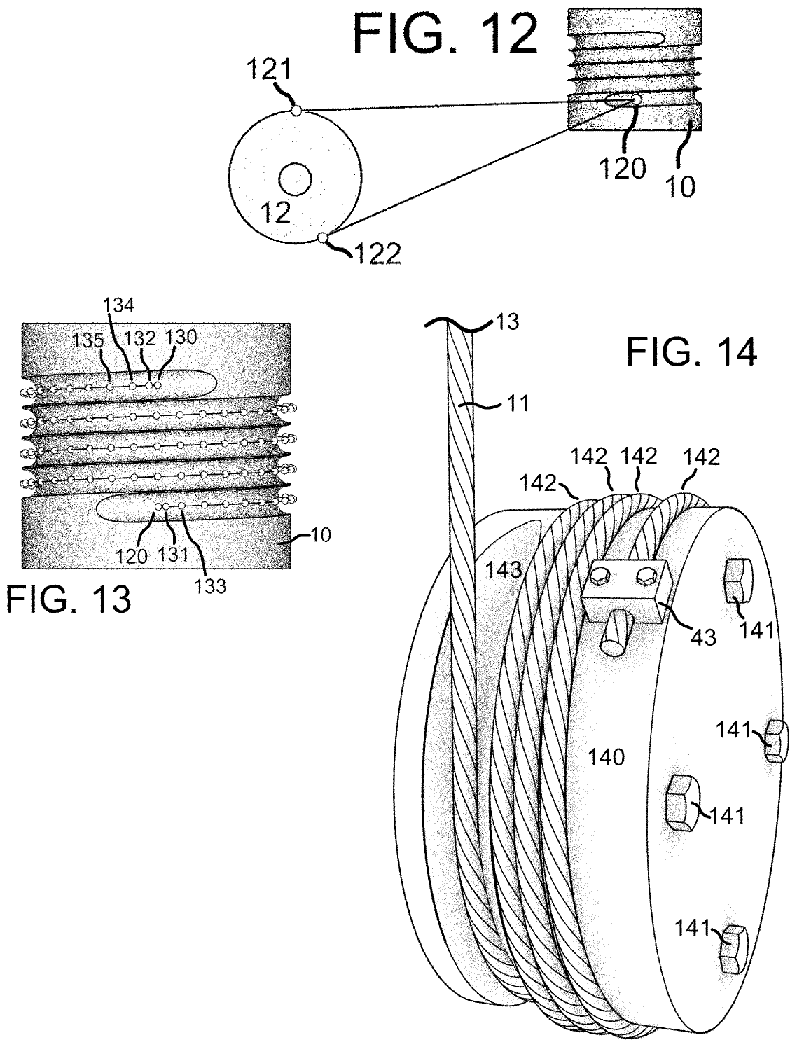

FIG. 14 is a perspective view of an attachment 140. An attachment 140 is the alternative to a pulley as the drum 10 proximal cable 11 force redirection element in a drum sheave appliance. An attachment 140 moves away from the drum 10 as the cable 11 is spooled out, and moves toward the drum 10 as the cable 11 is spooled back onto the drum 10. Attachments do not rotate as would a pulley, as indicated by the bolts 141 which affix the attachment 140 to the supporting member. The attachment shown has a deep cable 11 receiving groove 143 which allows compliant, controlled, large radius change in the departure location of the cable 11 from the attachment 140 as the cable 11 follows the change in drum 10 departure location upon cable inspool or outspool. The prior art attachments consisting of a cable thimble and quick link to a fixed portal in the attached member can respond to the spool instigated angle changes by building up stress until a frictional limit is exceeded and then jumping to a new equilibrium position. These jumps can be both accompanied by loud audible bangs, and cable 11 longitudinal shocks. For these reasons, attachments 140 with compliant cable 11 contact adaptation are the preferred attachments 140. The FIG. 14 attachment 140 has multiple dead wraps 142 and a cable 11 terminal clamp 43. Attachments with complaint cable 11 contact adaptation, strain relief, and terminal clamping are the most preferred attachment 140 embodiments.

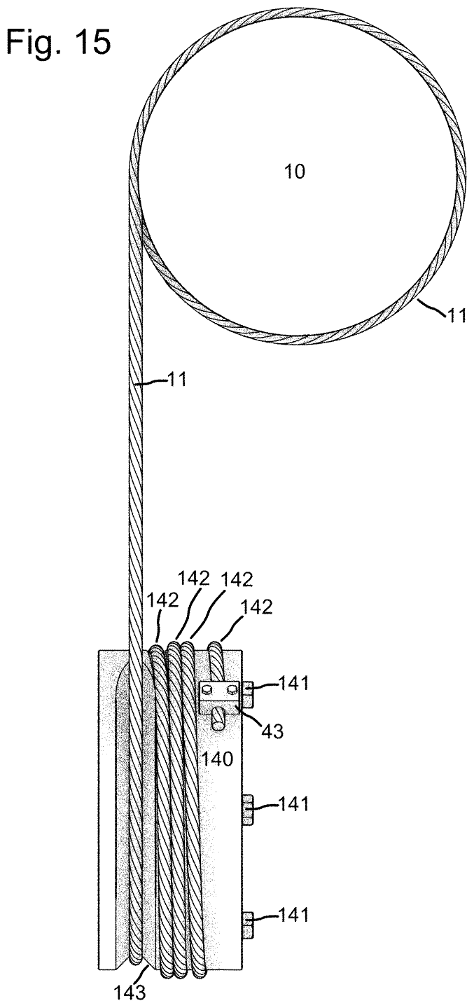

FIG. 15 shows is an orthographic side view of the attachment 140 of FIG. 14 and shows the correct relation to a proximal compensatingly grooved drum 10 to eliminate non-zero fleet angles on both the drum and attachment.

1. An apparatus comprising:
A helically grooved drum sheave with at least one cable entraining groove with;
at least one groove changing helical angle, reducing the cable to drum sheave groove fleet angle at one or more groove locations; and
one or more cables partially entrained in the at least one drum sheave grooves which;
spool-out or spool-in from the drum upon drum rotation, and span a gap to a cable redirection element for each cable, and contact and exert forces against this element for each cable; with the force redirection elements being pulleys.

2. The apparatus of claim 1 in which the cable to drum groove fleet angle is minimized at one or more of the at least one groove helical angle change locations.

3. The apparatus of claim 1 in which the drum groove helical angle change occurs at multiple locations on at least one revolution around the drum for at least one of the at least one drum grooves.

4. The apparatus of claim 3 in which drum groove helical angle changes occur on at least one groove, at locations tightly spaced enough such that the extent of the groove along the drum axis for the application required groove length, increases by less than the ISO 2768 fine tolerance distance versus the groove axial extent resulting from helical angle changes at the claim 3 locations and halfway between each of these locations.

5. The apparatus of claim 1 further comprising means to retain one or more of the groove entrained cables in a groove when the cable does not exert sufficient tension on the drum to resist cable unspooling.

6. An apparatus comprising:
A helically grooved drum sheave with at least one cable entraining groove with;
at least one groove changing helical angle, reducing the cable to drum sheave groove fleet angle at one or more groove locations; and
one or more cables partially entrained in the at least one drum sheave grooves which;
spool-out or spool-in from the drum upon drum rotation, and span a gap to a cable redirection element for each cable, and contact and exert forces against this element for each cable; with the force redirection elements being attachments which move toward or away from the drum in concert with the drum distal portion of the cable in contact with the attachment as the cable is spooled-in and spooled-out.

7. The apparatus of claim 6 in which the cable to drum groove fleet angle is minimized at one or more of the at least one groove helical angle change locations.

8. The apparatus of claim 6 in which the drum groove helical angle change occurs at multiple locations on at least one revolution around the drum for at least one of the at least one drum grooves.

9. The apparatus of claim 8 in which drum groove helical angle changes occur on at least one groove, at locations tightly spaced enough such that the extent of the groove along the drum axis for the application required groove length, increases by less than the ISO 2768 fine tolerance distance versus the groove axial extent resulting from helical angle changes at the claim 8 locations and halfway between each of these locations.

10. The apparatus of claim 6 further comprising means to retain one or more of the groove entrained cables in a groove when the cable does not exert sufficient tension on the drum to resist cable unspooling.

11. An apparatus comprising:
A helically grooved drum sheave with a plurality of cable entraining grooves with;
at least one groove changing helical angle, reducing the cable to drum sheave groove fleet angle at one or more groove locations; and
a plurality of cables each of which is partially entrained in one of the sheave groove plurality which;
spool-out or spool-in from the drum upon drum rotation, and span a gap to a cable redirection element for each cable, and contact and exert forces against this element for each cable; with the force redirection element for each cable being either an attachment which moves toward or away from the drum in concert with the drum distal portion of the cable in contact with the attachment as the cable is spooled-in and spooled-out, or is a pulley; and
at least one force redirection element is a pulley, and at least one force redirection element is an attachment.

12. The apparatus of claim 11 in which the cable to drum groove fleet angle is minimized at one or more of the groove plurality helical angle change locations.

13. The apparatus of claim 11 in which the drum groove helical angle change occurs at multiple locations on at least one revolution around the drum for at least one of the drum groove plurality.

14. The apparatus of claim 13 in which drum groove helical angle changes occur on at least one groove, at locations tightly spaced enough such that the extent of the groove along the drum axis for the application required groove length, increases by less than the ISO 2768 fine tolerance distance versus the groove axial extent resulting from helical angle changes at the claim 8 locations and halfway between each of these locations.

15. The apparatus of claim 11 further comprising means to retain one or more of the groove entrained cables in a groove when the cable does not exert sufficient tension on the drum to resist cable unspooling.
